(19) United States
(12) Patent Application Publication
(10) Pub. No.: US 2024/0337418 A1
(43) Pub. Date: Oct. 10, 2024

(54) PLATES INSTALLED AT THE BOTTOM OF SALT LAKES TO EXTRACT LITHIUM

(71) Applicant: N2E Materials Co., Ltd., Seoul (KR)

(72) Inventor: Jung Who OH, Incheon (KR)

(73) Assignee: N2E Materials Co., Ltd., Seoul (KR)

(21) Appl. No.: 18/617,551

(22) Filed: Mar. 26, 2024

(30) Foreign Application Priority Data
Apr. 4, 2023 (KR) 10-2023-0043950

(51) Int. Cl. F24S 10/13; B01D 1/00; C22B 3/22; C22B 26/12; F24S 70/20

(52) U.S. Cl. CPC F24S 10/13; B01D 1/0035; C22B 3/22; C22B 26/12; F24S 70/20

(57) ABSTRACT

The present disclosure relates to a plate installed at the bottom of a salt lake to extract lithium, the plate being able to increase a lithium extraction amount by being installed on the bottom of a salt lake or an evaporation pond for lithium extraction and quickly evaporating salt water. The plate installed at the bottom of a salt lake to extract lithium of the present disclosure includes a base configured to be brought in close contact with a bottom of a salt lake for extraction of lithium and having a box shape with an open top, a low specific heat panel configured to cover the open top of the base and made of a material of which specific heat is lower than specific heat of the bottom of the salt lake, and a low-emissivity coating layer formed in a predetermined thickness on a top of the low specific heat panel.

### CROSS REFERENCE TO RELATED APPLICATION

The present application claims priority to Korean Patent Applications No. 10-2023-0043950, filed on Apr. 4, 2023, the entire contents of which are incorporated herein for all purposes by this reference.

### BACKGROUND

### Technical Field

The present disclosure relates to a plate installed at the bottom of a salt lake to extract lithium, the plate being able to increase a lithium extraction amount by being installed on the bottom of a salt lake or an evaporation pond for lithium extraction and quickly evaporating salt water.

### Description of the Related Art

Lithium is generally used in various industries such as a rechargeable battery, glass, ceramic, an alloy, a lubricant, and pharmacy, and particularly, a rechargeable lithium battery is recently in the spotlight as a main power source of hybrid and electric vehicles, and the market of small-size batteries including a mobile phone and a laptop is also expected to grow as a huge market of a 100-time scale in the future.

Further, as environmental regulations are globally enhanced, it is expected that the application field will greatly expand to not only the hybrid and electric vehicle industry, but the electronic, chemical, energy industries, etc. in the near future and accordingly the demand for lithium will rapidly increase throughout the 21c industry at home and abroad.

There are minerals, salt water, seawater, etc. as the supply sources of lithium.

Minerals, such as spodumene, petalite, and lepidolite, contain a relatively large amount of lithium as about 1 to 15%, but processes such as flotation, high-temperature heating, pulverizing, acid mixing, extracting, refining, condensing, precipitating, etc. are required to extract lithium from minerals, so there is a problem that the collection process is complicated, the natural environment is unavoidably damaged, and the cost is high due to high energy consumption.

Further, it has been known that a total of 25×1011 tons of lithium is dissolved in the seawater, but the concentration of lithium in the seawater is not more than 0.17 ppm, so it is very inefficient to extract lithium from the seawater, which decreases economic efficiency.

Due to these problems, lithium is recently extracted usually from salt water. Salt water is obtained from natural salt lakes.

That is, salt water is pumped and kept in an evaporation pond on an open field from a natural salt lake or a salt lake, lithium is condensed tens of times by naturally evaporating the salt lake for a long period of time such as about several months or one year, the salt lake is transported to a factory, lithium phosphate is extracted through a refining process of removing impurities such as Mg, Ca, and B through deposition, and then lithium carbonate and lithium hydroxide are sequentially extracted through an additional refining process.

However, since the method of extracting lithium from salt water, as described above, keeps and leaves salt water in a salt lake or an evaporation pond so that the water is evaporated by the solar heat, an increase in water temperature is limited in the daytime. Further, since the specific heat of the bottom of salt lakes or evaporation ponds that is made of soil is high, the heat energy of salt water is taken by the soil even though the salt water absorbs the solar heat, so there is a problem that an increase in temperature is very slow.

### SUMMARY

The present disclosure has been made in an effort to solve the problems described above and an objective of the present disclosure is to provide a plate installed at the bottom of a salt lake to extract lithium, the plate being able to increase the extraction amount of lithium by being installed on the bottom of a salt lake for lithium extraction and quickly evaporating the salt water of the salt lake or an evaporation pond.

In order to achieve the objectives, a plate installed at the bottom of a salt lake to extract lithium of the present disclosure includes: a base configured to be brought in close contact with a bottom of a salt lake for extraction of lithium and having a box shape with an open top; a low specific heat panel configured to cover the open top of the base and made of a material of which specific heat is lower than specific heat of the bottom of the salt lake; and a low-emissivity coating layer formed in a predetermined thickness on a top of the low specific heat panel.

Further, the low specific heat panel may be made of one material of a tin plate or a steel plate.

Further, the low-emissivity coating layer may be formed using paint of which emissivity related to emission of absorbed solar heat is lower than emissivity of the bottom of the salt lake.

Meanwhile, it is preferable that a connection protrusion connecting an adjacent base and a connection groove corresponding to the connection protrusion are formed on outer sides of the base.

Further, steps on which the low specific heat panel is seated may be formed at upper ends of outer sides of the base.

Further, ribs supporting a bottom of the lower specific heat panel may be formed inside the base to form many separate air insulation layers inside the base.

In this case, a separation wall dividing up and down the inside of the base may be disposed inside the base to form many separate air insulation layers in a plurality of layers.

Meanwhile, it is preferable that anchors configured to be inserted into the bottom of the salt lake are formed at a lower portion of the base.

In this case, the anchors may be formed along an edge of the lower portion of the base to narrow downward and locking protrusions inclined upward may be formed inside lower ends of the anchors.

Further, an uneven pattern configured to increase a surface area may be formed on a surface of the low specific heat panel.

Since the plate installed at the bottom of a salt lake to extract lithium includes a base configured to be installed on the bottom of a salt lake for extraction of lithium, a low specific heat panel configured to cover an open top of the base, and a low-emissivity coating layer formed on the top of the low specific heat panel, an air insulation layer is formed in the base and it is possible to maximally suppress the phenomenon that heat of salt water loses while being conducted to the bottom of the salt lake through the base. Further, there is an effect that the temperature of salt water quickly increases while solar heat transfers to salt water only in the type of heat conduction due to a low specific heat bottom plate and the heat of the low specific heat bottom plate is kept for a long time because it is not emitted to salt water due to the low-emissivity coating layer, so thermal efficiency is greatly increased and the salt water quickly evaporates, whereby the concentration of lithium in the salt water increases and accordingly it is possible to considerably increase the extraction speed of lithium.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is a perspective view of a plate installed at the bottom of a salt lake to extract lithium according to the present disclosure;

FIG. 2 is an exploded perspective view of the plate installed at the bottom of a salt lake to extract lithium according to the present disclosure;

FIG. 3 is a cross-sectional view of FIG. 1;

FIG. 4 is a cross-sectional view showing a use state of the plate installed at the bottom of a salt lake to extract lithium according to the present disclosure;

FIGS. 5A to 5C are views showing various embodiments of uneven patterns formed to increase a surface area on the surface of a low specific heat panel constituting the present disclosure; and

FIG. 6 is a cross-sectional view showing the state in which many separate air insulation layers are formed up and down in a base constituting the present disclosure.

### DETAILED DESCRIPTION

Features and advantages of the present disclosure will be made clearer from the following detailed description of preferred embodiments based on accompanying drawings.

First, the terms and words used in the present specification and claims should be interpreted as having meanings and concepts relevant to the technical scope of the present disclosure based on the rule according to which an inventor can appropriately define the concepts of the terms to describe most appropriately the best method he or she knows for carrying out the disclosure.

Further, terms used in the specification and claims are used only in order to describe specific embodiments rather than limiting the present disclosure.

For example, singular forms are intended to include plural forms unless the context clearly indicates otherwise. Further, it will be further understood that the terms “comprise” or “include” or “have” used in this specification specify the presence of stated features, numerals, steps, operations, components, parts, or a combination thereof, but do not preclude the presence or addition of one or more other features, numerals, steps, operations, components, parts, or a combination thereof.

When an element such as a layer, a film, a region, and a plate is “on” another component, it can be “directly on” the other element or intervening elements may be present therebetween. On the contrary, when an element such as a layer, a film, a region, and a plate is “under” another component, it can be “directly under” the other element or intervening elements may be present therebetween.

Further, terms including ordinal numbers such as “first” and “second” used in the specification can be used to describe various components, but these components are not limited to the terms and the terms are used only for the purpose of discriminating one component from another component.

When an embodiment of the present disclosure is described below with reference to drawings, the same reference numerals are used for the same components and only different configuration is mainly described without overlap, if possible, for clearness.

In the present disclosure, a salt lake is a meaning that includes an evaporation pond formed on an open field by pumping salt water from a salt lake.

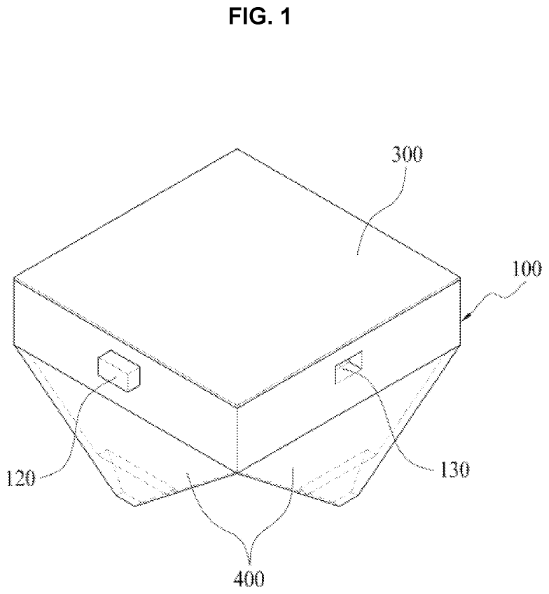

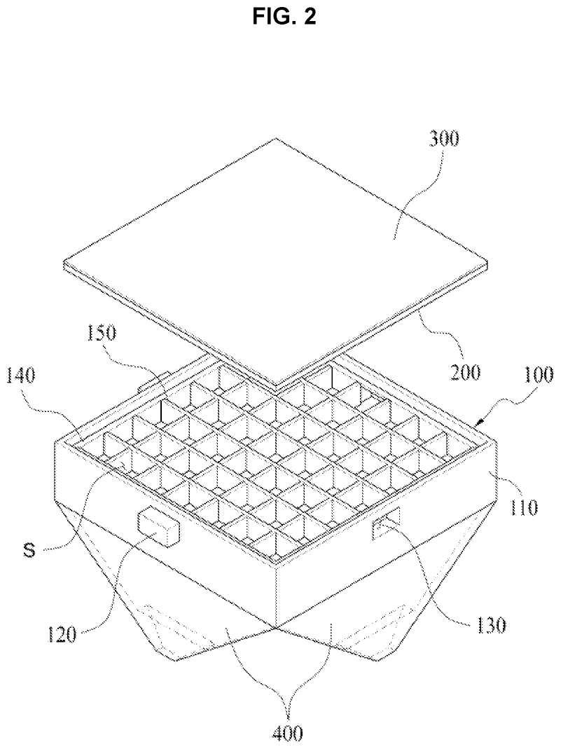

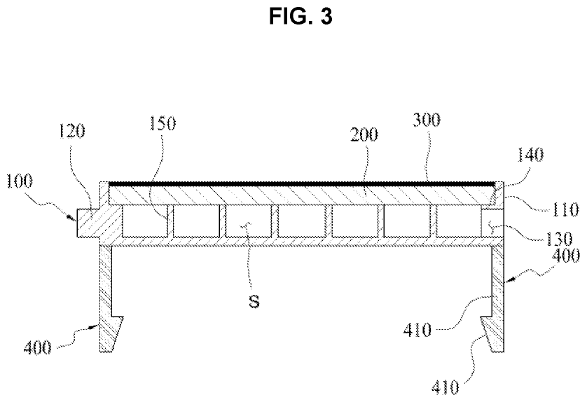

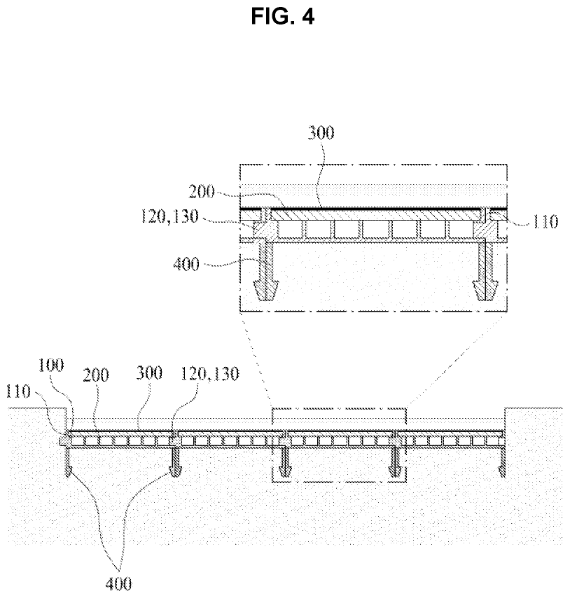

FIG. 1 is a perspective view of a plate installed at the bottom of a salt lake to extract lithium according to the present disclosure, FIG. 2 is an exploded perspective view of the plate installed at the bottom of a salt lake to extract lithium according to the present disclosure, FIG. 3 is a cross-sectional view of FIG. 1, and FIG. 4 is a cross-sectional view showing a use state of the plate installed at the bottom of a salt lake to extract lithium according to the present disclosure. As shown in the figures, a plate installed at the bottom of a salt lake to extract lithium according to the present disclosure includes a base 100, a low specific heat panel 200 coupled on the base 100, and a coated section 300 formed on the base 100.

The base 100, which is a flat box-shaped member having an open top and supposed to be placed on the bottom of a salt lake, is preferably made of a synthetic resin material to have low thermal conductivity and high strength and not to be damaged such as corrosion or deformation by contact with salt water.

Further, a connection protrusion 120 connecting an adjacent base 100 and a connection groove 130 corresponding to the connection protrusion 120 may be formed on the outer sides 110 of the base 100.

The low specific heat panel 200 is coupled to the open top of the base 100, thereby covering the open top of the base 100.

Further, the low specific heat panel 200 is made of a material that can effectively absorb the solar heat and is not easily damaged by external shock.

Considering this matter, it is preferable that the low specific heat panel 200 is made of a metallic material, and it is preferable that the low specific heat panel 200 is made of a material that is lower in specific heat than the bottom (clay) of salt lakes and is inexpensive such as a thin or steel plate in order to achieve more excellent efficiency.

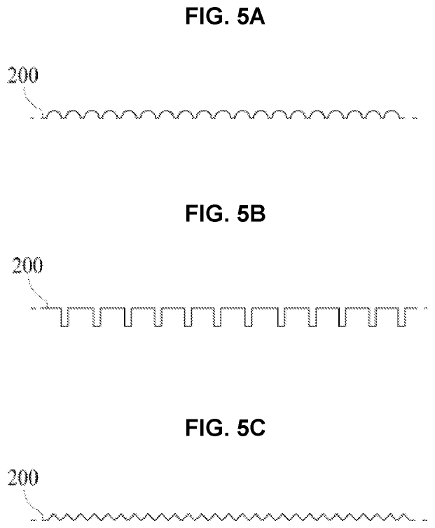

Further, an uneven pattern that increases a surface area may be formed on the surface of the lower specific heat panel 200 to be able to more effectively absorb solar heat. In this case, the unevenness may be formed in various shapes such as embossed shapes, grooves, or saw teeth, and the shape thereof is not necessarily limited (see FIGS. 5A to 5C).

Meanwhile, steps 140 on which the low specific heat panel 200 is seated may be formed at the upper ends of the outer sides 110 of the base 100.

In this case, the low specific heat panel 200 can be easily and accurately positioned over the open top of the base 100 by the steps 140 and a covering shape can be stably maintained.

The low-emissivity coating layer 300 is formed in a constant thickness on the top of the low specific heat panel 200.

Emissivity related to emission of absorbed solar heat of the low-emissivity coating layer 300 should be lower than that of the bottom of salt lakes to be able to achieve excellent effect and the low-emissivity coating layer 300 is made of paint having excellent durability, chemical resistance, wear resistance, impact resistance not to be easily damaged even though it is continuously exposed to salt water and direct sunlight.

Considering this matter, it is preferable to apply Polyurea paint to the low-emissivity coating layer 300.

Polyurea, which is a polymer compound elastomer in which isocyanate and amine are mixed, not only has low emissivity of 40% or less, but forms a high-tension and high-elasticity coating film within several seconds and has characteristics of high durability, wear resistance, impact resistance, waterproofness, etc.

Accordingly, it is possible to form the low-emissivity coating layer 300 in a way of heating and mixing isocyanate and amine through exclusive equipment and then applying or spraying at high pressure the mixture to the top of the low-emissivity coating layer 300 with the low specific heat panel 200 coupled to the base 100.

The low-emissivity coating layer 300 firmly attaches the low specific heat panel 200 to the base while filling the gap between the open top of the base 100 and the low specific heat panel 200 and completely sealing the base 100 in the forming process.

Accordingly, salt water cannot flow into the base 100 and an air insulation layer S is formed in the base 100, thereby being able to minimize the phenomenon that heat energy of salt water loses while being conducted to the bottom of a salt lake through the base 100.

Meanwhile, considering that a tin or steel plate is fundamentally white, it is preferable to form the low-emissivity coating layer 300 using black Polyurea paint so that solar energy is more effectively absorbed.

Further, such Polyurea paint also serves to improve the strength of tin.

When the low-emissivity coating layer 300 is formed in this way, emission of solar heat absorbed by the low specific heat panel 200 to slat water is maximally suppressed, so the heat of the low specific heat panel 200 is kept as long as possible, and the temperature of the salt water more quickly increases and evaporation of the salt water is promoted while the solar heat transfers to the salt water through heat conduction, whereby it is possible to improve the extraction speed of lithium.

Meanwhile, ribs 150 are formed in a predetermined height in the base 100.

The ribs 150 are vertically formed from the bottom of the base 100 up to the height at which the ribs 150 are in close contact with the bottom of the low specific heat panel 200, thereby horizontally stably supporting the lower portion of the low specific heat panel 200 and simultaneously improving the structural strength so that the low specific heat panel 200 and the base 100 are not damaged due to the load of salt water.

Further, the ribs 150 form many separate air insulation layers S in the base 100. Accordingly, even though an accident that salt water flows into the base 100 occurs, it is possible to minimize the inflow range of the salt water.

It is exemplified and shown that the ribs 150 are formed in a rectangular lattice shape in this embodiment, but the ribs 150 are not necessarily limited thereto and may be formed in various shapes and patterns such as a circle or a honeycomb having excellent structural strength.

Meanwhile, it is preferable that anchors 400 that are inserted into the bottom of a salt lake may be formed at the lower portion of the base 100 to prevent the base 100 from floating.

In this case, the anchors 400 may extend to protrude downward with a predetermined thickness around the edge of the lower portion of the base 100 and are formed in a wedge shape, which narrows downward, to be easily inserted into the bottom of a salt lake.

Further, the anchor 400 may have a locking protrusion 410, which is inclined upward inside the lower end thereof, not to float or separate from the bottom of a salt lake while being lifted by external shock or buoyancy after being inserted in the salt lake.

It is possible to easily insert and install the plate installed at the bottom of a salt lake to extract lithium of the present disclosure configured in this way into the bottom of a salt lake due to the wedge-shaped anchors 400, and once the plate is inserted in the bottom of a salt lake, it does not float or separate from the bottom of the salt lake by the anchors 410.

Further, not only the base 100 is easily, simply, and continuously connected with an adjacent base 100 by the connection protrusion 120 and the connection groove 130 formed on the outer sides 110 of the base 100, but it is possible to stably maintain the expanded installation state without floating or separating because uniform and strong connection force acts left, right, up, and down by the connection protrusion 120 and the connection groove 130.

As described above, when the plate installed at the bottom of a salt lake to extract lithium of the present disclosure is installed in the bottom of a salt lake, the phenomenon that heat of the salt water loses while being conducted to the bottom of the salt lake through the base 100 is maximally suppressed by the air insulation layer S formed in the base 100, and simultaneously, the temperature of the salt water is quickly increased by the low specific heat panel 200 and the heat of the low specific heat panel 200 is kept for a long time by the low-emissivity coating layer 300.

Therefore, the thermal efficiency of salt water greatly increases and the salt water quickly evaporates, so the concentration of lithium in the salt water remarkably increases and the extraction speed of lithium can be improved.

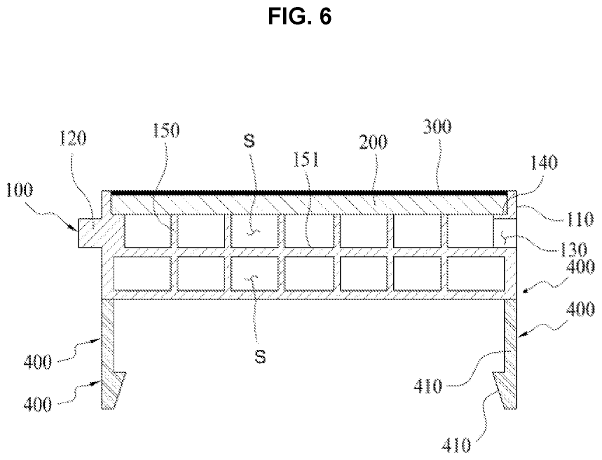

Meanwhile, as shown in FIG. 6, it is also possible to form many separate air insulation layers S in a plurality of layers by forming a separation wall 151 that divides up and down the inside of the base 100. In this case, it is possible to further minimize the loss due to conduction of the heat energy of salt water to the bottom of a salt lake through the base 100, so it is possible to further improve the extraction speed of lithium.

Preferred embodiments of the present disclosure were described above with reference to drawings, but the present disclosure may be changed and modified in various ways without departing from the spirit and the scope of the present disclosure, and the changes and modifications should be included in the range of the present disclosure.

What is claimed is:

1. A plate installed at the bottom of a salt lake to extract lithium, the plate comprising:
a base configured to be brought in close contact with a bottom of a salt lake for extraction of lithium and having a box shape with an open top;
a low specific heat panel configured to cover the open top of the base and made of a material of which specific heat is lower than specific heat of the bottom of the salt lake; and
a low-emissivity coating layer formed in a predetermined thickness on a top of the low specific heat panel.

2. The plate of claim 1, wherein the low specific heat panel is made of one material of a tin plate or a steel plate.

3. The plate of claim 1, wherein the low-emissivity coating layer is formed using paint of which emissivity related to emission of absorbed solar heat is lower than emissivity of the bottom of the salt lake.

4. The plate of claim 1, wherein a connection protrusion connecting an adjacent base and a connection groove corresponding to the connection protrusion are formed on outer sides of the base.

5. The plate of claim 1, wherein steps on which the low specific heat panel is seated are formed at upper ends of outer sides of the base.

6. The plate of claim 1, wherein ribs supporting a bottom of the lower specific heat panel are formed inside the base to form many separate air insulation layers inside the base.

7. The plate of claim 6, wherein a separation wall dividing up and down the inside of the base is disposed inside the base to form many separate air insulation layers in a plurality of layers.

8. The plate of claim 1, wherein anchors configured to be inserted into the bottom of the salt lake are formed at a lower portion of the base.

9. The plate of claim 8, wherein the anchors are formed along an edge of the lower portion of the base to narrow downward; and
locking protrusions inclined upward are formed inside lower ends of the anchors.

10. The plate of claim 1, wherein an uneven pattern configured to increase a surface area is formed on a surface of the low specific heat panel.
